(19) United States
(12) Patent Application Publication
(10) Pub. No.: US 2009/0005281 A1
(43) Pub. Date: Jan. 1, 2009

(54) Compositions Containing Amine Oxide Surfactants or Soil Penetration Agents

(76) Inventors: Howard David Hutton, III, Oregonia, OH (US); Kathryn Melissa Yu, Cincinnati, OH (US); William Jeffrey Gore, Cincinnati, OH (US); Charles Raymond Degenhardt, Cincinnati, OH (US); Amanda Valco Swinney, Ludlow, KY (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/052,053

(22) Filed: Mar. 20, 2008

Related U.S. Application Data
(60) Provisional application No. 60/920,017, filed on Mar. 26, 2007.

(51) Int. Cl. C11D 1/29

(52) U.S. Cl. 510/125; 510/123; 510/127

(57) ABSTRACT

The compositions of the present invention relate to improved shampoo compositions having from about 5 to about 50 wt. % of a detersive surfactant composition comprising at least one anionic surfactant, from about 0.1 to about 20 wt. % amine oxide, and from about 0.01 to about 5 wt. % cationic polymer, where the molar ratio of anionic surfactant to amine oxide is about 2:1 to about 40:1. The compositions of the present invention also relate to improved shampoo compositions having from about 5 to about 50 wt. % of a detersive surfactant composition, from about 0.1 to about 20 wt. % amine oxide, from about 0.01 to about 5 wt. % cationic polymer, and from about 0.1 to 10 wt. % soil penetration agent.

### CROSS REFERENCE TO RELATED APPLICATION

This application claims the benefit of U.S. Provisional Application No. 60/920,017.

### FIELD OF THE INVENTION

The present invention relates to hair cleansing shampoo compositions containing a soil penetration agent and amine oxide surfactants.

### BACKGROUND OF THE INVENTION

Human hair becomes soiled due to its contact with the surrounding environment, the use of styling and conditioning products, and from the sweat and sebum secreted by the scalp. The soiling of hair causes it to have a dirty, oily feel and an unattractive appearance. The soiling of hair also causes it to lay heavy and clump, which makes styling it more difficult. The soiling of the hair thus necessitates shampooing.

Shampooing cleans the hair by removing excess soil and sebum. Freshly washed hair looks and feels light, bouncy, and clean. The appearance and feel of freshly washed hair, however, is not long-lasting, as soil re-accumulates on the hair after shampooing and throughout the activities of the day. For those with oilier hair, those who engage in strenuous activity, i.e., exercise, or those who use certain styling or conditioning products on the hair, the freshly washed look and feel of hair is especially difficult to maintain.

Up until now, maintaining the appearance of freshly washed hair simply required more frequent shampooing, sometimes several times a day. Also, the use of clarifying or non-conditioning shampoos, which attempt to reduce the buildup of conditioning and styling products while depositing little or no additional conditioning agent, is known in the art. Clarifying shampoos, however, may leave hair dry, overly stripped of natural oils, and unconditioned. At the same time, clarifying shampoos may not succeed in consistently, throughout a population, removing a sufficient amount of soil from the hair. Thus, when different individuals use the same clarifying shampoo, varying quantities of soil will remain on the hair after shampooing. Overall, the benefit of longer-lasting clean hair or cleaner-longer hair, which does not feel stripped, has not been adequately addressed in the prior shampoo art.

Various surfactant systems and organic molecules that provide improved, consistent cleaning are known in the art of hard surface cleaners. Organic molecules, such as glycol ethers (i.e., ethylene glycol monobutylether, diethylene glycol monobutyl ether, or triethylene glycol monobutylether), terpenes (i.e., citronellol terpenes), and many others have been used in hard surface cleaners. Various surfactant systems, including systems that contain anionic surfactants and amine oxides, have been used in hard surface cleaners. Various combinations of surfactants, containing one or more of anionic surfactants, nonionic surfactants, zwitterionic (including amphoteric) surfactants, and cationic surfactants, have been taught in shampoos.

The surfactant systems of the shampoo art, however, do not teach optimized ratios of anionic and amine oxide surfactants or the combination of these surfactants with soil penetration agents to provide improved cleaning.

Based on the foregoing, there is a need for a hair cleansing shampoo which can provide longer-lasting clean or cleaner-longer benefits to the hair, while not overly stripping the hair and leaving it unconditioned. Specifically, there is a need to provide long lasting clean feel, a light bouncy feel, yet not leave the hair feeling stripped and dried out, as well as to provide ease of combing when the hair is wet. There is also a need for hair cleansing shampoo that rinses quickly from the hair, leaving the hair feeling conditioned but light and clean. Finally, there is a need for a hair cleansing shampoo that provides improved cleaning consistently, throughout a population.

None of the existing art provides all of the advantages and benefits of the present invention.

### SUMMARY OF THE INVENTION

The present invention is directed to a shampoo composition comprising: a) from about 5 to about 50 wt. % of a detersive surfactant composition comprising at least one anionic surfactant; b) from about 0.1 to about 20 wt. % amine oxide; and c) from about 0.01 to about 5 wt. % cationic polymer, wherein the molar ratio of anionic surfactant to amine oxide is about 2:1 to about 40:1.

The present invention is also directed to a shampoo composition comprising: a) from about 5 to about 50 wt. % of a detersive surfactant composition; b) from about 0.1 to about 20 wt. % amine oxide; c) from about 0.01 to about 5 wt. % cationic polymer; and d) from about 0.1 to about 10 wt. % soil penetration agent.

These and other features, aspects, and advantages of the present invention will become evident to those skilled in the art from a reading of the present disclosure.

### DETAILED DESCRIPTION OF THE INVENTION

While the specification concludes with claims which particularly point out and distinctly claim the invention, it is believed the present invention will be better understood from the following description.

All percentages, parts and ratios are based upon the total weight of the compositions of the present invention, unless otherwise specified. All such weights as they pertain to listed ingredients are based on the active level and, therefore, do not include solvents or by-products that may be included in commercially available materials, unless otherwise specified. The term “weight percent” may be denoted as “wt. %” herein.

All molecular weights as used herein are weight average molecular weights expressed as grams/mole, unless otherwise specified.

The term “charge density”, as used herein, refers to the ratio of the number of positive charges on a polymer to the molecular weight of said polymer.

The term “polymer” as used herein shall include materials whether made by polymerization of one type of monomer or made by two (i.e., copolymers) or more types of monomers.

The term “shampoo” as used herein means a composition for cleansing and conditioning hair or skin, including scalp, face, and body.

The term “suitable for application to human hair” as used herein means that the compositions or components thereof so described are suitable for use in contact with human hair and the scalp and skin without undue toxicity, incompatibility, instability, allergic response, and the like.

The shampoo compositions of the present invention comprise one or more detersive surfactants, including an amine oxide, and a cationic polymer, sometimes in combination with a soil penetration agent. Each of these components, as well as other relevant components, is described in detail hereinafter.

### Detersive Surfactant

The shampoo compositions of the present invention comprise one or more detersive surfactants. The detersive surfactant component is included in shampoo compositions of the present invention to provide cleansing performance. The detersive surfactant composition may be an anionic surfactant, a zwitterionic surfactant (which includes amphoteric surfactants), a cationic surfactant, a nonionic surfactant, or a combination thereof. Such surfactants should be physically and chemically compatible with the composition components described herein, or should not otherwise unduly impair product stability, aesthetics or performance.

The concentration of the detersive surfactant component in the composition should be sufficient to provide the desired cleaning and lather performance and generally ranges from about 5% to about 50%, typically from about 8% to about 30%, commonly from about 10% to about 25%, typically from about 12% to about 22%, by weight of the composition.

Suitable anionic detersive surfactants for use in the composition herein include those which are known for use in hair care or other personal care cleansing compositions. Suitable anionic surfactants for use in the compositions are the alkyl sulfates and alkyl ether sulfates. These materials have the respective formulae ROSO₃M and RO(C₂H₄O)ₓSO₃M, wherein R is alkyl or alkenyl of from about 8 to about 18 carbon atoms, x is an integer having a value of from 1 to 10, and M is a cation, such as ammonium, an alkanolamine, i.e., triethanolamine, a monovalent metal, i.e., sodium or potassium, or a polyvalent metal cation, i.e., magnesium or calcium. In various embodiments of the invention, with regard to both alkyl sulfates and alkyl ether sulfates, R has from about 8 to about 18 carbon atoms. In further embodiments, with regard to both alkyl and alkyl ether sulfates, R has from about 10 to about 16 carbon atoms. In still further embodiments, R has from about 12 to about 14 carbon atoms, with regard to both alkyl and alkyl ether sulfates.

The alkyl ether sulfates are typically made as condensation products of ethylene oxide and monohydric alcohols that have from about 8 to about 24 carbon atoms. The alcohols can be synthetic or they can be derived from fats, e.g., coconut oil, palm kernel oil, or tallow. Suitable alcohols include lauryl alcohol and straight chain alcohols derived from coconut oil or palm kernel oil. Such alcohols are generally reacted with from about 0 to about 10, typically from about 2 to about 5, commonly about 3 molar proportions of ethylene oxide. The resulting mixture of molecular species having, for example, an average of 3 moles of ethylene oxide per mole of alcohol, is sulfated and neutralized.

Suitable anionic detersive surfactants also include the water-soluble salts of organic, sulfuric acid reaction products conforming to the formula RSO₃M, wherein R¹ is a straight or branched chain, saturated, aliphatic hydrocarbon radical having from about 8 to about 24, typically from about 10 to about 18, carbon atoms, and M is a cation, as described hereinbefore.

Suitable anionic surfactants further include the reaction products of fatty acids esterified with isethionic acid and neutralized with sodium hydroxide where, for example, the fatty acids are derived from coconut oil or palm kernel oil; sodium or potassium salts of fatty acid amides of methyl tauride in which the fatty acids, for example, are derived from coconut oil or palm kernel oil. Other similar anionic surfactants are described in U.S. Pat. Nos. 2,486,921; 2,486,922; and 2,396,278.

Suitable anionic detersive surfactants also include the succinnates, examples of which include disodium N-octadecylsulfosuccinnate; disodium lauryl sulfosuccinate; diammonium lauryl sulfosuccinate; tetrasodium N-(1,2-dicarboxyethyl)-N-octadecylsulfosuccinate; diamyl ester of sodium sulfosuccinic acid; dihexyl ester of sodium sulfosuccinic acid; and dioctyl esters of sodium sulfosuccinic acid.

Suitable anionic detersive surfactants further include olefin sulfonates having about 10 to about 24 carbon atoms. In addition to the true alkene sulfonates and a proportion of hydroxy alkanesulfonates, the olefin sulfonates can contain minor amounts of other materials, such as alkene disulfonates, depending upon the reaction conditions, proportion of reactants, the nature of the starting olefins and impurities in the olefin stock and side reactions during the sulfonation process. A non-limiting example of such an alpha olefin sulfonate mixture is described in U.S. Pat. No. 3,332,880, which description is incorporated herein by reference.

A class of anionic detersive surfactants suitable for use in the compositions is the beta-alkyloxy alkane sulfonates. These surfactants conform to the formula:

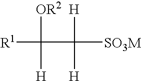

where R¹ is a straight chain alkyl group having from about 6 to about 20 carbon atoms, R² is a lower alkyl group having from about 1 to about 3 carbon atoms, typically 1 carbon atom, and M is a water-soluble cation as described hereinbefore.

Suitable anionic detersive surfactants for use in the compositions include ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, triethanolamine lauryl sulfate, monoethanolamine cocoyl sulfate, monoethanolamine lauryl sulfate, sodium tridecyl benzene sulfonate, sodium dodecyl benzene sulfonate, sodium cocoyl isethionate, and combinations thereof. In some embodiments, the anionic surfactant is selected from the group consisting of sodium lauryl sulfate, ammonium lauryl sulfate, sodium laureth sulfate, and ammonium laureth sulfate.

The compositions of the present invention may also comprise additional surfactants for use in combination with the anionic surfactants described hereinbefore. Suitable such surfactants include, zwitterionic (which include amphoteric), nonionic, and cationic surfactants.

Suitable zwitterionic surfactants for use in the composition herein include those which are known for use in hair care or other personal cleansing compositions. Non-limiting examples of suitable zwitterionic surfactants are described in U.S. Pat. Nos. 5,104,646 (Bolich Jr. et al.) and 5,106,609 (Bolich Jr. et al.). Zwitterionic detersive surfactants suitable for use in the composition include those surfactants broadly described as derivatives of aliphatic secondary and tertiary amines, in which the aliphatic radical can be straight or branched chain and wherein one of the aliphatic substituents contains from about 8 to about 18 carbon atoms and one contains an anionic group (i.e., carboxy, sulfonate, sulfate, phosphate, or phosphonate). Examples of such zwitterionic surfactants include cocoamphoacetate, cocoamphodiacetate, lauroamphoacetate, lauroamphodiacetate, and mixtures thereof.

Suitable nonionic surfactants include nonionic surfactants having an HLB of 7 or more and comprising one or more polyethyleneoxide chains, wherein each polyethyleneoxide chain contains, on average, at least about 5 ethylene oxide units. Nonionic surfactants comprising one or more polyethyleneoxide chain wherein each polyethyleneoxide chain contains, on average, at least about 5 ethylene oxide units include polyoxyethylene alkyl ethers, polyethyleneglycol fatty acid esters, polyoxyethylene castor oil, polyoxyethylene hydrogenated castor oil, polyoxyethylene fatty amides and their monoethanolamine and diethanolamine derivatives, and polyethoxylated fatty amines, with a number of ethylene oxide groups of at least about 50, and mixtures thereof.

Suitable nonionic surfactants comprising one or more polyethyleneoxide chains include polyoxyethylene alkyl ethers having at least about 5, typically from about 10 to 20, ethylene oxide units. Non-limiting examples of such nonionic surfactants are steareth-10 and steareth-15. Also suitable for use as nonionic surfactants are nonionic surfactants having an HLB of 7 or more, which are free of polyethyleneoxide chains. Nonionic surfactants free of polyethyleneoxide chains include polyglycerolated fatty acids, polyglycerolated fatty amides, polyglycerolated alkyl phenols, polyglycerolated alpha-diols, polyglycerolated alcohols, alkyl polyglucosides, and sugar esters. Suitable nonionic surfactants free of polyethyleneoxide chains are selected from alkyl polyglucosides, sugar esters, polyglyceryl fatty acid esters, alkyl polyglyceryl ethers, and mixtures thereof.

Additionally, suitable nonionic surfactants include alkyl polysaccharide (APS) surfactants, such as the alkyl polyglycosides. Such surfactants are described in U.S. Pat. No. 4,565,647 to Llenado, issued Jan. 21, 1986, which discloses APS surfactants having a hydrophobic group with about 6 to about 30 carbon atoms and polysaccharide (e.g., polyglycoside) as the hydrophilic group. Optionally, there can be a polyalkylene-oxide group joining the hydrophobic and hydrophilic moieties. The alkyl group (i.e., the hydrophobic moiety) can be saturated or unsaturated, branched or unbranched, and unsubstituted or substituted (e.g., with hydroxy or cyclic rings).

Also among suitable nonionic surfactants are polyethylene glycol (PEG) glyceryl fatty esters, such as those of the formula R(O)OCH₂CH(OH)CH₂(OCH₂CH₂)ₙOH, wherein n is an integer from about 5 to about 200, typically from about 20 to about 100, and R is an aliphatic hydrocarbyl having from about 8 to about 20 carbon atoms.

Cationic surfactants suitable for use in the present invention include quaternary ammonium salts, amido-amines having at least one fatty chain containing at least about 8 carbon atoms, or mixtures thereof. Suitable quaternary ammonium salts have the following general formula: N⁺(R₁R₂R₃R₅)X⁻, wherein R₁ is selected from linear and branched radicals comprising from about 8 to about 30 carbon atoms; R₂ is selected from linear and branched radicals comprising from about 8 to about 30 carbon atoms or the same group as radicals R₃ and R₄; R₃ and R₄ are independently selected from linear and branched aliphatic radicals comprising from about 1 to about 4 carbon atoms, and aromatic radicals such as aryl and alkylaryl, wherein the aliphatic radicals may comprise at least one hetero atom such as oxygen, nitrogen, sulphur, and halogen, and the aliphatic radicals are chosen, for example, from alkyl, alkoxy, and alkylamide radicals; and X⁻ is an anion selected from halides such as chloride, bromide, and iodide, (C₂-C₆)alkyl sulphates, such as methyl sulphate, phosphates, alkyl, and alkylaryl sulphonates, and anions derived from organic acids, such as acetate and lactate.

Non-limiting examples of such suitable cationic surfactants include cetrimonium chloride, stearimonium chloride, behentrimonium chloride, behenamidopropyltrimonium methosulfate, stearamidopropyltrimonium chloride, arachidtrimonium chloride, and mixtures thereof.

Suitable amido-amine cationic surfactants have the following general formula: R′₁—CONH(CH₂)ₙNR′₂R′₃, wherein R′₁, is selected from linear and branched radicals comprising about 8 to about 30 carbon atoms; R₁₂ and R₁₃ are independently selected from hydrogen, linear and branched aliphatic radicals comprising from about 1 to about 4 carbon atoms, and aromatic radicals such as aryl and alkylaryl, wherein the aliphatic radicals may comprise at least one hetero atom such as oxygen, nitrogen, sulphur, and halogens, and the aliphatic radicals are chosen, for example, from alkyl, alkoxy and alkylamide radicals; and n is an integer from about 1 to about 4.

Non-limiting examples of such suitable amido-amines include stearamidopropyldimethylamine, behenamidopropyldimethylamine, behenamidopropyldiethylamine, behenamidoethyldiethyl-amine, behenamidoethyldimethylamine, arachidamidopropyldimethylamine, arachidamido-propyldiethylamine, arachidamidoethyldiethylamine, arachidamidoethyldimethylamine, and mixtures thereof.

Any such surfactant known in the art for use in hair or personal care products may be used, provided that the surfactant is also chemically and physically compatible with the components of the composition, or does not otherwise unduly impair product performance, aesthetics or stability. The concentration of the surfactants in the composition may vary with the cleansing or lather performance desired, the surfactant selected, the desired product concentration, the presence of other components in the composition, and other factors well known in the art.

Non-limiting examples of anionic, zwitterionic, nonionic, cationic, and additional surfactants suitable for use in the compositions are described in McCutcheon's, Emulsifiers and Detergents, 1989 Annual, published by M. C. Publishing Co., and U.S. Pat. Nos. 3,929,678; 2,658,072; 2,438,091; and 2,528,378.

### Amine Oxide

The compositions of the present invention may also comprise an amine oxide surfactant. Amine oxide surfactants are generally categorized as zwitterionic surfactants. Suitable amine oxide surfactants have the formula:

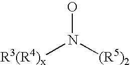

wherein R³ is a straight or branched alkyl, hydroxyalkyl, or alkyl phenyl group, or mixtures thereof, containing from about 8 to about 22 carbon atoms; R⁴ is an alkylene, alkylether, or hydroxyalkylene group, wherein the alkyl moiety contains from about 2 to about 3 carbon atoms, or mixtures thereof; x is from about 0 to about 3; and each R⁵ is independently an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure.

Non-limiting examples of suitable amine oxide compounds include dimethyl-dodecylamine oxide, oleyldi(2-hydroxyethyl) amine oxide, dimethyltetradecylamine oxide, di(2-hydroxyethyl)-tetradecylamine oxide, dimethylhexadecylamine oxide, behenamine oxide, cocamine oxide, decyltetradecylamine oxide, dihydroxyethyl C12-15 alkoxypropylamine oxide, dihydroxyethyl cocamine oxide, dihydroxyethyl lauramine oxide, dihydroxyethyl stearamine oxide, dihydroxyethyl tallowamine oxide, hydrogenated palm kernel amine oxide, hydrogenated tallowamine oxide, hydroxyethyl hydroxypropyl C12-15 alkoxypropylamine oxide, lauramine oxide, myristamine oxide, myristyl/cetyl amine oxide, oleamidopropylamine oxide, oleamine oxide, palmitamine oxide, PEG-3 lauramine oxide, dimethyl lauramine oxide, potassium trisphosphonomethylamine oxide, stearamine oxide, and tallowamine oxide. In various embodiments, the amine oxide is a dimethyl lauramine oxide.

The amine oxide is present in the composition in an effective amount, generally from about 0.1% to about 20%, typically from about 0.1% to about 15%, commonly from about 0.5% to about 10%, by weight.

In various embodiments, the shampoo composition contains a combination of an anionic surfactant and an amine oxide surfactant. In further embodiments, the shampoo composition contains a combination of sodium lauryl sulfate and dimethyl lauramine oxide. In some embodiments, where the shampoo composition contains a combination of anionic surfactant and amine oxide surfactant, the molar ratio of anionic surfactant to amine oxide surfactant is from about 2:1 to about 40:1. In certain embodiments, where the shampoo composition contains a combination of anionic surfactant and amine oxide surfactant, the molar ratio of anionic surfactant to amine oxide is from about 2:1 to about 30:1. In further embodiments, where the shampoo composition contains a combination of anionic surfactant and amine oxide surfactant, the molar ratio of anionic surfactant to amine oxide is from about 2:1 to about 15:1. In still further embodiments, where the shampoo composition contains a combination of anionic surfactant and amine oxide surfactant, the molar ratio of anionic surfactant to amine oxide is about 2:1 to about 10:1. In further embodiments, where the shampoo composition contains a combination of anionic surfactant and amine oxide surfactant, the molar ratio of anionic surfactant to amine oxide is about 2:1 to about 5:1. In yet further embodiments, where the shampoo composition contains a combination of anionic surfactant and amine oxide surfactant, the molar ratio of anionic surfactant to amine oxide is about 3:1.

In various embodiments, the shampoo composition contains a combination of sodium lauryl sulfate and dimethyl lauramine oxide, wherein the molar ratio of sodium lauryl sulfate to dimethyl lauramine oxide is from about 2:1 to about 40:1, generally from about 2:1 to about 30:1, typically from about 2:1 to about 15:1, commonly from about 2:1 to about 10:1, generally from about 2:1 to about 5:1, typically about 3:1.

Amine oxide surfactants generally show good compatibility with other surfactants, i.e., forming mixed micelles. Without being bound to any theory, it is believed that the compatibility between an anionic surfactant and an amine oxide is optimized at certain ratios of the two surfactants. Specifically, at certain ratios, the interaction between the anionic surfactant and the amine oxide, at interfaces and in surfactant aggregates, is particularly favorable, resulting in tighter packing (i.e., reduced distance between charged groups) and increased surface activity. This increase in surface activity can be measured using well known measurements, such as critical micelle concentration and interfacial tension. These measurements correlate with emulsification efficiency and cleaning performance.

The selection of suitable surfactants and the adjustment of the molar ratio of the surfactants is an example of optimizing the types and levels of surfactants in a composition in order to guide the performance characteristics of the composition, i.e., cleansing performance and conditioning performance. Another example of optimizing the types and levels of surfactants in a composition relates to the degree of ethoxylation of a surfactant. In the context of anionic surfactants, for example, it may be desirable to optimize the degree of ethoxylation of the surfactant.

It is believed that a cleansing composition with a high degree of ethoxylation typically forms more coacervates, in the presence of cationic polymers, and deposits more conditioning agent on the hair. A cleansing composition with a low degree of ethoxylation typically demonstrates improved cleansing and deposits less conditioning agent on the hair. In some embodiments, the anionic surfactant system for use in the compositions of the invention has a degree of ethoxylation from about 0 to about 6. The combination of such an anionic surfactant system with an amine oxide provides enhanced cleansing performance.

### Cationic Polymers

The compositions of the present invention may contain a cationic polymer. The concentration of cationic polymer in the composition generally ranges from about 0.01% to about 5%, typically from about 0.05% to about 2%, commonly from about 0.1% to about 1%, by weight of the composition. A suitable cationic polymer will have a cationic charge density of at least about 0.3 meq/gm, typically at least about 0.5 meq/gm, commonly at least about 0.7 meq/gm, but also generally less than about 7 meq/gm, typically less than about 5 meq/gm, at the pH of intended use of the composition. The pH of intended use of the composition generally ranges from about pH 3 to about pH 9, typically from about pH 4 to about pH 8. A suitable cationic polymer will generally have an average molecular weight ranging from about 1,000 to about 10,000,000, typically from about 10,000 to about 5,000,000, commonly about 20,000 to about 2,000,000.

Suitable cationic polymers for use in the compositions of the present invention contain cationic nitrogen-containing moieties such as quaternary ammonium or cationic protonated amino moieties. The cationic protonated amines can be primary, secondary, or tertiary amines (typically secondary or tertiary), depending upon the particular species and the selected pH of the composition. Any anionic counterions can be used in association with the cationic polymers so long as the polymers remain soluble in water, in the composition, or in a coacervate phase of the composition, and so long as the counterions are physically and chemically compatible with the components of the composition or do not otherwise unduly impair product performance, stability or aesthetics. Non-limiting examples of such counterions include halides (e.g., chloride, fluoride, bromide, iodide), sulfate and methylsulfate.

Non-limiting examples of such polymers are described in the CTFA Cosmetic Ingredient Dictionary, 3rd edition, edited by Estrin, Crosley, and Haynes, (The Cosmetic, Toiletry, and Fragrance Association, Inc., Washington, D.C. (1982)). Non-limiting examples of suitable cationic polymers include copolymers of vinyl monomers having cationic protonated amine or quaternary ammonium functionalities with water soluble spacer monomers such as acrylamide, methacrylamide, alkyl and dialkyl acrylamides, alkyl and dialkyl methacrylamides, alkyl acrylate, alkyl methacrylate, vinyl caprolactone or vinyl pyrrolidone.

Suitable cationic protonated amino and quaternary ammonium monomers, for inclusion in the cationic polymers of the composition herein, include vinyl compounds substituted with dialkylaminoalkyl acrylate, dialkylaminoalkyl methacrylate, monoalkylaminoalkyl acrylate, monoalkylaminoalkyl methacrylate, trialkyl methacryloxyalkyl ammonium salt, trialkyl acryloxyalkyl ammonium salt, diallyl quaternary ammonium salts, and vinyl quaternary ammonium monomers having cyclic cationic nitrogen-containing rings such as pyridinium, imidazolium, and quaternized pyrrolidone, e.g., alkyl vinyl imidazolium, alkyl vinyl pyridinium, alkyl vinyl pyrrolidone salts.

Other suitable cationic polymers for use in the compositions include copolymers of 1-vinyl-2-pyrrolidone and 1-vinyl-3-methylimidazolium salt (e.g., chloride salt) (referred to in the industry by the Cosmetic, Toiletry, and Fragrance Association, “CTFA”, as Polyquaternium-16); copolymers of 1-vinyl-2-pyrrolidone and dimethylaminoethyl methacrylate (referred to in the industry by CTFA as Polyquaternium-11); cationic diallyl quaternary ammonium-containing polymers, including, for example, dimethyldiallylammonium chloride homopolymer, copolymers of acrylamide and dimethyldiallylammonium chloride (referred to in the industry by CTFA as Polyquaternium 6 and Polyquaternium 7, respectively); amphoteric copolymers of acrylic acid including copolymers of acrylic acid and dimethyldiallylammonium chloride (referred to in the industry by CTFA as Polyquaternium 22), terpolymers of acrylic acid with dimethyldiallylammonium chloride and acrylamide (referred to in the industry by CTFA as Polyquaternium 39), and terpolymers of acrylic acid with methacrylamidopropyl trimethylammonium chloride and methylacrylate (referred to in the industry by CTFA as Polyquaternium 47). Suitable cationic substituted monomers are the cationic substituted dialkylaminoalkyl acrylamides, dialkylaminoalkyl methacrylamides, and combinations thereof. These suitable monomers conform to the formula:

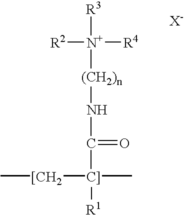

wherein R¹ is hydrogen, methyl or ethyl; each of R², R³, and R⁴ are independently hydrogen or a short chain alkyl having from about 1 to about 8 carbon atoms, typically from about 1 to about 5 carbon atoms, commonly from about 1 to about 2 carbon atoms; n is an integer having a value of from about 1 to about 8, typically from about 1 to about 4; and X is a counterion. The nitrogen attached to R², R³, and R⁴ may be a protonated amine (primary, secondary, or tertiary), but is typically a quaternary ammonium wherein each of R², R³, and R⁴ are alkyl groups, a non-limiting example of which is polymethyacrylamidopropyl trimonium chloride, available under the trade name Polycare 133, from Rhone-Poulenc, Cranberry, N.J., U.S.A.

Other suitable cationic polymers for use in the composition include polysaccharide polymers, such as cationic cellulose derivatives and cationic starch derivatives. Suitable cationic polysaccharide polymers include those which conform to the formula:

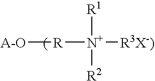

wherein A is an anhydroglucose residual group, such as a starch or cellulose anhydroglucose residual; R is an alkylene oxyalkylene, polyoxyalkylene, or hydroxyalkylene group, or combination thereof; R¹, R², and R³ independently are alkyl, aryl, alkylaryl, arylalkyl, alkoxyalkyl, or alkoxyaryl groups, each group containing up to about 18 carbon atoms, and the total number of carbon atoms for each cationic moiety (i.e., the sum of carbon atoms in R¹, R², and R³) typically being about 20 or less; and X is an anionic counterion as described hereinbefore.

Suitable cationic cellulose polymers are salts of hydroxyethyl cellulose reacted with trimethyl ammonium substituted epoxide, referred to in the industry (CTFA) as Polyquaternium 10 and available from Amerchol Corp. (Edison, N.J., USA) in their Polymer LR, JR, and KG series of polymers. Other suitable types of cationic cellulose includes the polymeric quaternary ammonium salts of hydroxyethyl cellulose reacted with lauryl dimethyl ammonium-substituted epoxide, referred to in the industry (CTFA) as Polyquaternium 24. These materials are available from Amerchol Corp., under the tradename Polymer LM-200.

Other suitable cationic polymers include cationic guar gum derivatives, such as guar hydroxypropyltrimonium chloride, specific examples of which include the Jaguar series commercially available from Rhone-Poulenc Incorporated and the N-Hance series commercially available from Aqualon Division of Hercules, Inc. Other suitable cationic polymers include quaternary nitrogen-containing cellulose ethers, some examples of which are described in U.S. Pat. No. 3,962,418. Other suitable cationic polymers include copolymers of etherified cellulose, guar and starch, some examples of which are described in U.S. Pat. No. 3,958,581. When used, the cationic polymers herein are either soluble in the composition or are soluble in a complex coacervate phase in the composition formed by the cationic polymer and the detersive surfactant components described hereinbefore. Complex coacervates of the cationic polymer can also be formed with other charged materials in the composition.

### Soil Penetration Agents

In some embodiments of the invention, the composition comprises a soil penetration agent. A soil penetration agent is a component that is effective in penetrating and swelling simple and complex mixtures of soils (i.e., silicone, fatty alcohols, quaternary compounds, polymers, particulates, etc.). A soil penetration agent should be selected so as to be safe for use on hair and skin as well as chemically and physically compatible with the components of the composition or not otherwise unduly impairing product performance, aesthetics, or stability.

The soil penetration agents of the invention include hydrophobic organic solvents and organic solvents characterized by low water-solubility and low volatility (i.e., high flashpoint). Typically, the water solubility of a soil penetration agent is less than about 3%, generally less than about 1%, commonly less than about 0.5%, by weight of the soil penetration agent (in grams) per 100 mL of water at a temperature of about 25° C. The flash point of a soil penetration agent (as measured according to American Society for Testing and Materials (ASTM) method D93-02a) is typically at least about 65° C., commonly at least about 70° C., typically at least about 80° C. The boiling point of the soil penetration agent is generally above about 150° C., while the solidification point is typically above about 20° C. Additionally, partitioning parameters, such as CLogP, and solubility parameters, such as Hansen parameters, may guide the selection of a soil penetration agent. The soil penetration agents of the invention are typically characterized by a CLogP value greater than about 1.

Suitable soil penetration agents include organic hydrocarbons, ethers, and alcohols, which possess the above solubility and flashpoint parameters. Non-limiting examples include benzyl alcohol, 1,4-cyclohexanedimethanol, 2-ethyl-1-hexanol, furfuryl alcohol, and 1,2-hexanediol; esters, such as ethyl lactate, methyl ester, ethyl acetoacetate, ethylene glycol monobutyl ether acetate, diethylene glycol monoethyl ether acetate, and diethylene glycol monobutyl ether acetate; glycol ethers, such as ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, and propylene glycol butyl ether; glycols, such as propylene glycol, diethylene glycol, hexylene glycol (2-methyl-2, 4 pentanediol), triethylene glycol, and dipropylene glycol, and mixtures thereof.

In some embodiments, the soil penetration agent is a glycol ether. In further embodiments, the soil penetration agent is selected from the group consisting of ethylene glycol phenyl ether, ethylene glycol monobutyl ether, propylene glycol n-butyl ether, and combinations thereof.

The concentration of the soil penetration agent in the composition may vary with the cleansing or lather performance desired, the surfactant selected, the desired product concentration, the presence of other components in the composition, and other factors well known in the art. The composition generally comprises from about 0.1% to about 10%, typically about 0.5% to about 8%, commonly about 1% to about 5% soil penetration agent, by weight of the composition.

Without being limited to any theory, it is believed that a sparingly soluble soil penetration agent will migrate in use, i.e., in the shower, to the soil interface (i.e., on the hair). Once in contact with the soil, especially soils that are solids at typical in-use (i.e., shower) temperatures, the soil penetration agent will penetrate and soften the soil, thereby allowing surfactants to emulsify and remove the soil. Thus, there is potential for synergistic interaction between the surfactant(s) and soil penetration agent(s), and the selection of the surfactant and the soil penetration agent may affect this synergistic interaction. Using some soil penetration agents and some surfactants, at optimum surfactant ratios, it is likely that a microemulsion will form in use. The interaction between the surfactant and the soil penetration agent, as guided by the type and level of surfactants and soil penetration agents present, may influence emulsification and soil removal, thereby resulting in the removal of more soil from the hair surface.

Furthermore, a newly-cleaned hair surface (with or without further deposited actives, i.e., silicone or polymers), treated with the compositions of the invention, repels soil/sebum or impedes the further spread of soil/sebum. This repulsion is believed to be due to a change in the surface energy of the hair, brought about by the increased removal of soil/sebum from the hair by the composition of the invention. As a result, hair treated with the composition stays cleaner longer. The newly-cleaned hair surface is also more uniform, in terms of surface energy, and it is freer of deposits, thereby providing a more homogeneous surface for subsequent treatment with hair care actives such as conditioners, styling aids, and colorants. This allows the hair care actives to provide more consistent results, especially throughout a population of users (i.e., users who initially have varying amounts of soil on their hair will have similar, low levels of soil on their hair, after using the compositions of the invention).

The soil penetration agent and the surfactant system of the invention may also contribute to quick-lathering and quick-rinsing. Specifically, it is believed that the surfactant system contributes to quick-lathering. The selection of particular surfactant types and ratios contributes to the formation of an increased number of small surfactant aggregates. Because these surfactant aggregates are small, they migrate rapidly to the air/water interface, where they rapidly generate lather. Depending on the types and ratios of the surfactants, the surfactant system may produce lather about 20% to about 30% faster than conventional shampoo compositions, i.e., composition of Example 7.

The soil penetration agent, on the other hand, contributes to quick-rinsing. As a largely water-insoluble organic molecule, the soil penetration agent is solubilized in the surfactant matrix, both before use (in the bottle) and during use. Upon rinsing of the composition, though, the organic molecule is released from the surfactant matrix into the rinse solution, where it acts as a lather suppressor. Depending on the type and concentration of the soil penetration agent, it may reduce as much as about 99% of the lather. Generally, the soil penetration agent reduces as much as about 90% of the lather, typically as much as about 80%, commonly as much as about 70%. If lesser reductions in lather are desired, i.e., about 50% or less, the type and concentration of the soil penetration agent may be modified accordingly.

### Additional Components

The compositions of the present invention may further comprise one or more additional components known for use in hair care or personal care products, provided that the additional components are physically and chemically compatible with the components of the composition described herein, or do not otherwise unduly impair product stability, aesthetics or performance. Individual concentrations of such additional components may range from about 0.001% to about 10%.

Non-limiting examples of additional components for use in the composition include nonionic polymers, conditioning agents (hydrocarbon oils, fatty esters, silicones), anti dandruff agents, suspending agents, viscosity modifiers, dyes, nonvolatile solvents or diluents (water soluble and insoluble), pearlescent aids, foam boosters, additional surfactants or nonionic cosurfactants, pediculocides, pH adjusting agents, perfumes, preservatives, chelants, proteins, skin active agents, sunscreens, UV absorbers, and vitamins.

### 1. Nonionic Polymers

Polyalkylene glycols having a molecular weight of more than about 1000 are useful herein. Useful are those having the following general formula:

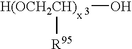

wherein R⁹⁵ is selected from the group consisting of H, methyl, and mixtures thereof. Polyethylene glycol polymers useful herein are PEG-2M (also known as Polyox WSR® N-10, which is available from Union Carbide and as PEG-2,000); PEG-5M (also known as Polyox WSR® N-35 and Polyox WSR® N-80, available from Union Carbide and as PEG-5,000 and Polyethylene Glycol 300,000); PEG-7M (also known as Polyox WSR® N-750 available from Union Carbide); PEG-9M (also known as Polyox WSR® N-3333 available from Union Carbide); and PEG-14 M (also known as Polyox WSR® N-3000 available from Union Carbide).

### 2. Conditioning Agents

Conditioning agents include any material which is used to give a particular conditioning benefit to hair and/or skin. The conditioning agents useful in the compositions of the present invention typically comprise a water insoluble, water dispersible, non-volatile, liquid that forms emulsified, liquid particles. Suitable conditioning agents for use in the composition are those conditioning agents characterized generally as silicones (e.g., silicone oils, cationic silicones, silicone gums, high refractive silicones, and silicone resins), organic conditioning oils (e.g., hydrocarbon oils, glycerine, glycerine derivatives, polyolefins, and fatty esters) or combinations thereof, or those conditioning agents which otherwise form liquid, dispersed particles in the aqueous surfactant matrix herein. Such conditioning agents should be physically and chemically compatible with the components of the composition, and should not otherwise unduly impair product stability, aesthetics or performance.

The concentration of the conditioning agent in the composition should be sufficient to provide the desired conditioning benefits, and as will be apparent to one of ordinary skill in the art. Such concentration can vary with the conditioning agent, the conditioning performance desired, the average size of the conditioning agent particles, the type and concentration of other components, and other like factors.

a. Silicones

The conditioning agent of the compositions of the present invention is typically an insoluble, non-volatile silicone conditioning agent. The silicone conditioning agent particles may comprise volatile silicone, non-volatile silicone, or combinations thereof. The silicone conditioning agent particles may comprise a silicone fluid conditioning agent and may also comprise other ingredients, such as a silicone resin, to improve silicone fluid deposition efficiency or enhance glossiness of the hair.

The concentration of the silicone conditioning agent generally ranges from about 0.01% to about 10%, commonly from about 0.1% to about 8%, typically from about 0.1% to about 5%, commonly from about 0.2% to about 3%. Non-limiting examples of suitable silicone conditioning agents, and optional suspending agents for the silicone, are described in U.S. Reissue Pat. No. 34,584, U.S. Pat. No. 5,104,646, and U.S. Pat. No. 5,106,609. The silicone conditioning agents for use in the compositions of the present invention generally have a viscosity, as measured at 25° C., from about 20 to about 2,000,000 centistokes (“csk”), typically from about 1,000 to about 1,800,000 csk, commonly from about 50,000 to about 1,500,000 csk, typically from about 100,000 to about 1,500,000 csk.

The dispersed silicone conditioning agent particles typically have a number average particle diameter ranging from about 0.01 μm to about 50 μm. For small particle application to hair, the number average particle diameters typically range from about 0.01 μm to about 4 μm, commonly from about 0.01 μm to about 2 μm, generally from about 0.01 μm to about 0.5 μm. For larger particle application to hair, the number average particle diameters typically range from about 4 μm to about 50 μm, commonly from about 6 μm to about 30 μm, generally from about 9 μm to about 20 μm, typically from about 12 μm to about 18 μm.

Background material on silicones including sections discussing silicone fluids, gums, and resins, as well as manufacture of silicones, are found in Encyclopedia of Polymer Science and Engineering, vol. 15, 2d ed., pp 204 308, John Wiley & Sons, Inc. (1989).

i. Silicone Oils

Silicone fluids include silicone oils, which are flowable silicone materials having a viscosity, as measured at 25° C., less than 1,000,000 csk, typically from about 5 csk to about 1,000,000 csk, commonly from about 100 csk to about 600,000 csk. Suitable silicone oils for use in the compositions of the present invention include polyalkyl siloxanes, polyaryl siloxanes, polyalkylaryl siloxanes, polyether siloxane copolymers, and mixtures thereof. Other insoluble, non-volatile silicone fluids having hair conditioning properties may also be used.

ii. Amino and Cationic Silicones

Cationic silicone fluids suitable for use in the compositions of the present invention include, but are not limited to, those which conform to the general formula (V):

(R₁)ₐG₃₋ₐSi—(—OSiG₂)ₙ—(—OSiG_{b}(R₁)_{2-b})ₘ—O—SiG₃₋ₐ(R₁)ₐ

wherein G is hydrogen, phenyl, hydroxy, or a C₁-C₈ alkyl, typically a methyl; a is 0 or an integer having a value from 1 to 3, typically 0; b is 0 or 1, typically 1; n is a number from 0 to 1,999, typically from 49 to 499; m is an integer from 1 to 2,000, typically from 1 to 10; the sum of n and m is a number from 1 to 2,000, typically from 50 to 500; R₁ is a monovalent radical conforming to the general formula C_{q}H_{2q}L, wherein q is an integer having a value from 2 to 8 and L is selected from the following groups:

### —N(R₂)CH₂—CH₂—N(R₂)₂

### —N(R₂)₂

### —N(R₂)₃A⁻

### —N(R₂)CH₂—CH₂—NR₂H₂A⁻

wherein R₂ is hydrogen, phenyl, benzyl, or a saturated hydrocarbon radical, typically an alkyl radical from about C₁ to about C₂₀, and A is a halide ion.

A suitable cationic silicone corresponding to formula (V) is the polymer known as “trimethylsilylamodimethicone”, which is shown below in formula (VI):

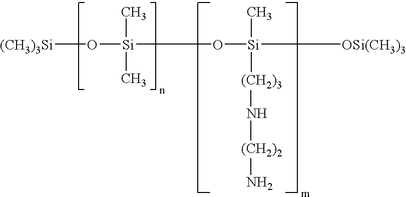

Other silicone cationic polymers which may be used in the compositions of the present invention are represented by the general formula (VII):

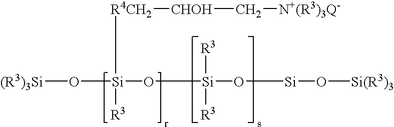

wherein R³ is a monovalent hydrocarbon radical from C₁ to C₁₈, typically an alkyl or alkenyl radical, such as methyl; R⁴ is a hydrocarbon radical, typically a C₁ to C₁₈ alkylene radical or a C₁₀ to C₁₈ alkyleneoxy radical, commonly a C₁ to C₈ alkyleneoxy radical; Q is a halide ion, typically chloride; r is an average statistical value from 2 to 20, typically from 2 to 8; s is an average statistical value from 20 to 200, typically from 20 to 50. A suitable polymer of this class is known as UCARE SILICONE ALE 56™, available from Union Carbide.

iii. Silicone Gums

Other silicone fluids suitable for use in the compositions of the present invention are the insoluble silicone gums. These gums are polyorganosiloxane materials having a viscosity, as measured at 25° C., of greater than or equal to 1,000,000 csk. Silicone gums are described in U.S. Pat. No. 4,152,416; Noll and Walter, Chemistry and Technology of Silicones, New York: Academic Press (1968); and in General Electric Silicone Rubber Product Data Sheets SE 30, SE 33, SE 54 and SE 76. Specific non-limiting examples of silicone gums for use in the compositions of the present invention include polydimethylsiloxane, (polydimethylsiloxane) (methylvinylsiloxane) copolymer, poly(dimethylsiloxane) (diphenylsiloxane)(methylvinylsiloxane) copolymer and mixtures thereof.

iv. High Refractive Index Silicones

Other non-volatile, insoluble silicone fluid conditioning agents that are suitable for use in the compositions of the present invention are those known as “high refractive index silicones,” having a refractive index of at least about 1.46, typically at least about 1.48, commonly at least about 1.52, typically at least about 1.55. The refractive index of the polysiloxane fluid will generally be less than about 1.70, typically less than about 1.60. In this context, polysiloxane “fluid” includes oils as well as gums.

v. Silicone Resins

Silicone resins may be included in the silicone conditioning agent of the compositions of the present invention. These resins are highly cross-linked polymeric siloxane systems. The cross-linking is introduced through the incorporation of trifunctional and tetrafunctional silanes with monofunctional or difunctional, or both, silanes during manufacture of the silicone resin.

Silicone materials and silicone resins in particular, can conveniently be identified according to a shorthand nomenclature system known to those of ordinary skill in the art as “MDTQ” nomenclature. Under this system, the silicone is described according to presence of various siloxane monomer units which make up the silicone. Briefly, the symbol M denotes the monofunctional unit (CH₃)₃SiO_{0.5}; D denotes the difunctional unit (CH₃)₂SiO; T denotes the trifunctional unit (CH₃)SiO_{1.5}; and Q denotes the quadra or tetra functional unit SiO₂. Primes of the unit symbols (e.g. M′, D′, T′, and Q′) denote substituents other than methyl, and are specifically defined for each occurrence.

b. Organic Conditioning Oils

The conditioning component of the compositions of the present invention may also comprise from about 0.05% to about 3%, typically from about 0.08% to about 1.5%, commonly from about 0.1% to about 1%, of at least one organic conditioning oil, either alone or in combination with other conditioning agents, such as the silicones.

i. Hydrocarbon Oils

Suitable organic conditioning oils for use as conditioning agents in the compositions of the present invention include, but are not limited to, hydrocarbon oils having at least about 10 carbon atoms, such as cyclic hydrocarbons, straight chain aliphatic hydrocarbons (saturated or unsaturated), and branched chain aliphatic hydrocarbons (saturated or unsaturated), including polymers and mixtures thereof. Straight chain hydrocarbon oils typically are from about C₁₂ to about C₁₉. Branched chain hydrocarbon oils, including hydrocarbon polymers, typically will contain more than 19 carbon atoms.

ii. Polyolefins

Organic conditioning oils for use in the compositions of the present invention can also include liquid polyolefins, typically liquid poly-α-olefins, commonly hydrogenated liquid poly-α-olefins. Polyolefins for use herein are prepared by polymerization of C₄ to about C₁₄ olefinic monomers, typically from about C₆ to about C₁₂.

Non-limiting examples of olefinic monomers for use in preparing the polyolefin liquids herein include ethylene, propylene, 1-butene, 1-pentene, 1-hexene, 1-octene, 1-decene, 1-dodecene, 1-tetradecene, branched chain isomers such as 4-methyl-1-pentene, and mixtures thereof. Also suitable for preparing the polyolefin liquids are olefin-containing refinery feedstocks or effluents. Typical hydrogenated α-olefin monomers include, but are not limited to, 1-hexene to 1-hexadecenes, 1-octene to 1-tetradecene, and mixtures thereof.

iii. Fatty Esters

Other suitable organic conditioning oils for use as the conditioning agent in the compositions of the present invention include, but are not limited to, fatty esters having at least 10 carbon atoms. These fatty esters include esters with hydrocarbyl chains derived from fatty acids or alcohols (e.g. mono-esters, polyhydric alcohol esters). The hydrocarbyl radicals of the fatty esters hereof may include other compatible functionalities, such as amides and alkoxy moieties (e.g., ethoxy or ether linkages, etc.).

c. Other Conditioning Agents

Also suitable for use in the compositions herein are the conditioning agents described by the Procter & Gamble Company in U.S. Pat. Nos. 5,674,478, and 5,750,122. Also suitable for use herein are those conditioning agents described in U.S. Pat. Nos. 4,529,586 (Clairol), 4,507,280 (Clairol), 4,663,158 (Clairol), 4,197,865 (L'Oreal), 4,217,914 (L'Oreal), 4,381,919 (L'Oreal), and 4,422,853 (L'Oreal).

### 3. Anti-Dandruff Actives

The compositions of the present invention may also contain an anti-dandruff agent. Suitable, non-limiting examples of anti-dandruff particulates include: pyridinethione salts, zinc carbonate, azoles, such as ketoconazole, econazole, and elubiol, selenium sulfide, particulate sulfur, and mixtures thereof. A typical anti-dandruff particulate is pyridinethione salt. Such anti-dandruff particulate should be physically and chemically compatible with the components of the composition, and should not otherwise unduly impair product stability, aesthetics or performance.

a. Pyridinethione Salts

Pyridinethione anti-dandruff particulates, especially 1-hydroxy-2-pyridinethione salts, are suitable particulate anti-dandruff agents for use in compositions of the present invention. The concentration of pyridinethione anti-dandruff particulate typically ranges from about 0.1% to about 4%, by weight of the composition, generally from about 0.1% to about 3%, commonly from about 0.3% to about 2%. Suitable pyridinethione salts include those formed from heavy metals such as zinc, tin, cadmium, magnesium, aluminum and zirconium, generally zinc, typically the zinc salt of 1-hydroxy-2-pyridinethione (known as “zinc pyridinethione” or “ZPT”), commonly 1-hydroxy-2-pyridinethione salts in platelet particle form, wherein the particles have an average size of up to about 20μ, typically up to about 5μ, commonly up to about 2.5μ. Salts formed from other cations, such as sodium, may also be suitable. Pyridinethione anti-dandruff agents are described, for example, in U.S. Pat. No. 2,809,971; U.S. Pat. No. 3,236,733; U.S. Pat. No. 3,753,196; U.S. Pat. No. 3,761,418; U.S. Pat. No. 4,345,080; U.S. Pat. No. 4,323,683; U.S. Pat. No. 4,379,753; and U.S. Pat. No. 4,470,982.

b. Anti-Microbial Actives

In addition to the anti-dandruff active selected from polyvalent metal salts of pyrithione, the present invention may further comprise one or more anti-fungal or anti-microbial actives in addition to the metal pyrithione salt actives. Suitable anti-microbial actives include coal tar, sulfur, whitfield's ointment, castellani's paint, aluminum chloride, gentian violet, octopirox (piroctone olamine), ciclopirox olamine, undecylenic acid and it's metal salts, potassium permanganate, selenium sulphide, sodium thiosulfate, propylene glycol, oil of bitter orange, urea preparations, griseofulvin, 8-Hydroxyquinoline ciloquinol, thiobendazole, thiocarbamates, haloprogin, polyenes, hydroxypyridone, morpholine, benzylamine, allylamines (such as terbinafine), tea tree oil, clove leaf oil, coriander, palmarosa, berberine, thyme red, cinnamon oil, cinnamic aldehyde, citronellic acid, hinokitol, ichthyol pale, Sensiva SC-50, Elestab HP-100, azelaic acid, lyticase, iodopropynyl butylcarbamate (IPBC), isothiazalinones such as octyl isothiazalinone and azoles, and combinations thereof. Typical anti-microbials include itraconazole, ketoconazole, selenium sulphide and coal tar.

i. Azoles

Azole anti-microbials include imidazoles such as benzimidazole, benzothiazole, bifonazole, butaconazole nitrate, climbazole, clotrimazole, croconazole, eberconazole, econazole, elubiol, fenticonazole, fluconazole, flutimazole, isoconazole, ketoconazole, lanoconazole, metronidazole, miconazole, neticonazole, omoconazole, oxiconazole nitrate, sertaconazole, sulconazole nitrate, tioconazole, thiazole, and triazoles such as terconazole and itraconazole, and combinations thereof. When present in the composition, the azole anti-microbial active is included in an amount from about 0.01% to about 5%, typically from about 0.1% to about 3%, and commonly from about 0.3% to about 2%, by weight of the composition. Especially common for use herein is ketoconazole.

ii. Selenium Sulfide

Selenium sulfide is a particulate anti-dandruff agent suitable for use in the anti-microbial compositions of the present invention, effective concentrations of which range from about 0.1% to about 4%, by weight of the composition, typically from about 0.3% to about 2.5%, commonly from about 0.5% to about 1.5%. Selenium sulfide is generally regarded as a compound having one mole of selenium and two moles of sulfur, although it may also be a cyclic structure that conforms to the general formula SeₓS_{y}, wherein x+y=8. Average particle diameters for the selenium sulfide are typically less than 15 μm, as measured by forward laser light scattering device (e.g. Malvern 3600 instrument), typically less than 10 μm. Selenium sulfide compounds are described, for example, in U.S. Pat. No. 2,694,668; U.S. Pat. No. 3,152,046; U.S. Pat. No. 4,089,945; and U.S. Pat. No. 4,885,107.

iii. Sulfur

Sulfur may also be used as a particulate anti-microbial/anti-dandruff agent in the anti-microbial compositions of the present invention. Effective concentrations of the particulate sulfur are typically from about 1% to about 4%, by weight of the composition, typically from about 2% to about 4%.

iv. Keratolytic Agents

The present invention may further comprise one or more keratolytic agents such as Salicylic Acid.

v. Additional Anti-Microbial Actives

Additional anti-microbial actives of the present invention may include extracts of melaleuca (tea tree) and charcoal. The present invention may also comprise combinations of anti-microbial actives. Such combinations may include octopirox and zinc pyrithione combinations, pine tar and sulfur combinations, salicylic acid and zinc pyrithione combinations, octopirox and climbasole combinations, and salicylic acid and octopirox combinations, and mixtures thereof. sulfur are typically from about 1% to about 4%, commonly from about 2% to about 4%.

### 4. Humectant

The compositions of the present invention may contain a humectant. The humectants herein are selected from the group consisting of polyhydric alcohols, water soluble alkoxylated nonionic polymers, and mixtures thereof. The humectants, when used herein, are typically used at levels of from about 0.1% to about 20%, commonly from about 0.5% to about 5%. Polyhydric alcohols useful herein include glycerin, sorbitol, propylene glycol, butylene glycol, hexylene glycol, ethoxylated glucose, 1,2-hexane diol, hexanetriol, dipropylene glycol, erythritol, trehalose, diglycerin, xylitol, maltitol, maltose, glucose, fructose, sodium chondroitin sulfate, sodium hyaluronate, sodium adenosine phosphate, sodium lactate, pyrrolidone carbonate, glucosamine, cyclodextrin, and mixtures thereof.

Water soluble alkoxylated nonionic polymers useful herein include polyethylene glycols and polypropylene glycols having a molecular weight of up to about 1000 such as those with CTFA names PEG-200, PEG-400, PEG-600, PEG-1000, and mixtures thereof.

### 5. Suspending Agent

The compositions of the present invention may further comprise a suspending agent at concentrations effective for suspending water-insoluble material in dispersed form in the compositions or for modifying the viscosity of the composition. Such concentrations range from about 0.1% to about 10%, typically from about 0.3% to about 5.0%.

Suspending agents useful herein include anionic polymers and nonionic polymers. Useful herein are vinyl polymers such as cross linked acrylic acid polymers with the CTFA name Carbomer, cellulose derivatives and modified cellulose polymers such as methyl cellulose, ethyl cellulose, hydroxyethyl cellulose, hydroxypropyl methyl cellulose, nitro cellulose, sodium cellulose sulfate, sodium carboxymethyl cellulose, crystalline cellulose, cellulose powder, polyvinylpyrrolidone, polyvinyl alcohol, guar gum, hydroxypropyl guar gum, xanthan gum, arabia gum, tragacanth, galactan, carob gum, guar gum, karaya gum, carragheenin, pectin, agar, quince seed (Cyclonia oblonga Mill), starch (rice, corn, potato, wheat), algae colloids (algae extract), microbiological polymers such as dextran, succinoglucan, pulleran, starch-based polymers such as carboxymethyl starch, methylhydroxypropyl starch, alginic acid-based polymers such as sodium alginate, alginic acid propylene glycol esters, acrylate polymers such as sodium polyacrylate, polyethylacrylate, polyacrylamide, polyethyleneimine, and inorganic water soluble material such as bentonite, aluminum magnesium silicate, laponite, hectonite, and anhydrous silicic acid.

### Other Optional Components

The compositions of the present invention may contain also vitamins and amino acids such as: water soluble vitamins such as vitamin B1, B2, B6, B12, C, pantothenic acid, pantothenyl ethyl ether, panthenol, biotin, and their derivatives, water soluble amino acids such as asparagine, alanin, indole, glutamic acid and their salts, water insoluble vitamins such as vitamin A, D, E, and their derivatives, water insoluble amino acids such as tyrosine, tryptamine, and their salts.

The compositions of the present invention may also contain pigment materials such as inorganic, nitroso, monoazo, disazo, carotenoid, triphenyl methane, triaryl methane, xanthene, quinoline, oxazine, azine, anthraquinone, indigoid, thionindigoid, quinacridone, phthalocianine, botanical, natural colors, including: water soluble components such as those having C. I. Names.

The compositions of the present invention may also contain antimicrobial agents which are useful as cosmetic biocides and antidandruff agents including: water soluble components such as piroctone olamine, water insoluble components such as 3,4,4′-trichlorocarbanilide (trichlosan), triclocarban and zinc pyrithione.

The compositions of the present invention may also contain chelating agents.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### NON-LIMITING EXAMPLES

The shampoo compositions illustrated in the following Examples illustrate specific embodiments of the shampoo compositions of the present invention, but are not intended to be limiting thereof. Other modifications can be undertaken by the skilled artisan without departing from the spirit and scope of this invention. These exemplified embodiments of the shampoo composition of the present invention provide enhanced cleansing benefits to the hair.

The shampoo compositions illustrated in the following Examples are prepared by conventional formulation and mixing methods. All exemplified amounts are listed as weight percents and exclude minor materials such as diluents, preservatives, color solutions, imagery ingredients, botanicals, and so forth, unless otherwise specified. All percentages are based on weight unless otherwise specified.

### Shampoo Examples 1-7

| Ingredient | 1 | 2 | 3 | 4 | 5 | 6 | 7 |
|---|---|---|---|---|---|---|---|
| Sodium Laureth Sulfate | 15.00 | | 6.00 | 15.00 | | 6.00 | 10.00 |
| Sodium Lauryl Sulfate | | 15.00 | 12.00 | | 15.00 | 12.00 | 6.00 |
| Dimethyl Lauramine Oxide | 5.00 | 5.00 | 3.00 | 5.00 | 5.00 | 3.00 | |
| Ethylene Glycol Phenyl Ether | | | | 1.00 | 1.00 | 1.00 | |
| Guar Hydroxypropyl | 0.20 | 0.20 | 0.20 | 0.20 | 0.20 | 0.20 | |
| trimonium chloride¹ | | | | | | | |
| Polyquaterium-10² | | | | | | | 0.40 |
| Dimethicone³ | 0.5 | 0.5 | 0.5 | 0.5 | 0.5 | 0.5 | 0.50 |
| Ethylene Glycol Distearate | 1.50 | 1.50 | 1.50 | 1.50 | 1.50 | 1.50 | 1.50 |
| Cocamide MEA | | | | | | | 1.50 |
| 5-Chloro-2-methyl-4-isothiazolin- | 0.0005 | 0.0005 | 0.0005 | 0.0005 | 0.0005 | 0.0005 | 0.0005 |
| 3-one, Kathon CG | | | | | | | |
| Sodium Benzoate | 0.25 | 0.25 | 0.25 | 0.25 | 0.25 | 0.25 | 0.25 |
| DisodiumEDTA | 0.13 | 0.13 | 0.13 | 0.13 | 0.13 | 0.13 | 0.13 |
| Perfume | 0.70 | 0.70 | 0.70 | 0.70 | 0.70 | 0.70 | 0.70 |
| Citric Acid/Sodium Citrate | pH QS | pH QS | pH QS | pH QS | pH QS | pH QS | pH QS |
| Dihydrate | | | | | | | |
| Sodium Chloride/Ammonium | Visc. | Visc. | Visc. | Visc. | Visc. | Visc. | Visc. |
| Xylene Sulfonate | QS | QS | QS | QS | QS | QS | QS |
| Water | QS | QS | QS | QS | QS | QS | QS |

¹N-Hance 3269 (with Mol. W. of ~500,000 and 0.8 meq/g) available from Aqulaon/Hercules.
²Polymer LR30M available from Amerchol/Dow Chemical.
³Viscasil 330M available from General Electric Silicones.

Data on several examples shows the soil cleaning benefit of the anionic surfactant/amine oxide combinations as well as the additional cleaning benefits of the soil penetration agent, in comparison with comparative example 7.

| | | | Comparative |
|---|---|---|---|
| | Example | Example | Example |
| Cleaning Test | 1 | 6 | 7 |
| Oil Water Emulsification Test | 133 | 266 | 100 |
| (Indexed vs Comparative) | | | |
| Human Lipid Assay | 150 | 200 | 100 |
| (Indexed vs Comparative) | | | |

The Oil Water Emulsification test is a measure of the ability of a composition to emulsify an oil and maintain the emulsification over time. Different compositions (compositions of examples 1 and 6) of the invention as well as a comparative composition (example 7) are added to a water- and olive oil-filled vial at 25° C. Specifically, to a vial containing 18 mL of water and 20 mL of olive oil is added 2 mL of one of the above compositions (compositions of examples 1, 6, or 7). The ratio of water to such composition is approximately 10:1 (by volume), to mimic in-use (i.e., shower) conditions. The resulting mixtures are shaken uniformly for about 3 minutes (and up to about 15 minutes) using a standard orbital mixer. The volume of water and the time required for the water layer to reappear from the emulsified phase is recorded. The faster the emulsion disperses and the water separates, the less stable the emulsion. The above data show indices of time required for water separation. The emulsion formed in example 1 is 33% more stable, while the emulsion formed in example 6 is more than twice as stable as the comparative composition.

The Human Lipid Assay is a soil removal test using real sebum. The test involves the use of several vials, each having an interior coated with a known mass of sebum (i.e., 0.2 g). Different compositions (compositions of examples 1, 6, or 7) are added to the sebum-coated vials at 25° C. The ratio of water to such composition is approximately 10:1 (by volume), to mimic in-use (i.e., shower) conditions. The resulting mixtures are shaken uniformly for about 3 minutes (and up to about 15 minutes) using standard magnetic stirrers. Approximately 10 minutes after shaking has stopped, the solution is poured out of the vial and analyzed for sebum concentration. The percent of initial sebum present is indexed in the above table. As seen in the above table, the composition of example 1 removed 50% more sebum, while the composition of example 6 removed twice as much sebum as the comparative composition.

What is claimed is:

1. A shampoo composition comprising:
a. from about 5 to about 50 wt. % of a detersive surfactant composition comprising at least one anionic surfactant;
b. from about 0.1 to about 20 wt. % amine oxide; and
c. from about 0.01 to about 5 wt. % cationic polymer
wherein the molar ratio of anionic surfactant to amine oxide is about 2:1 to about 40:1.

2. The shampoo composition of claim 1 wherein said anionic surfactant selected from the group consisting of ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, triethanolamine lauryl sulfate, monoethanolamine cocoyl sulfate, monoethanolamine lauryl sulfate, sodium tridecyl benzene sulfonate, sodium dodecyl benzene sulfonate, sodium cocoyl isethionate, and mixtures thereof.

3. The shampoo composition of claim 1 wherein said amine oxide is selected from the group consisting of dimethyl-dodecylamine oxide, oleyldi(2-hydroxyethyl) amine oxide, dimethyltetradecylamine oxide, di(2-hydroxyethyl)-tetradecylamine oxide, dimethylhexadecylamine oxide, behenamine oxide, cocamine oxide, decyltetradecylamine oxide, dihydroxyethyl C₁₂-C₁₅ alkoxypropylamine oxide, dihydroxyethyl cocamine oxide, dihydroxyethyl lauramine oxide, dihydroxyethyl stearamine oxide, dihydroxyethyl tallowamine oxide, hydrogenated palm kernel amine oxide, hydrogenated tallowamine oxide, hydroxyethyl hydroxypropyl C₁₂-C₁₅ alkoxypropylamine oxide, lauramine oxide, myristamine oxide, myristyl/cetyl amine oxide, oleamidopropylamine oxide, oleamine oxide, palmitamine oxide, PEG-3 lauramine oxide, dimethyl lauramine oxide, potassium trisphosphonomethylamine oxide, stearamine oxide, and tallowamine oxide.

4. The shampoo composition of claim 1 wherein the molar ratio of anionic surfactant to amine oxide is about 2:1 to about 10:1.

5. The shampoo composition of claim 1 wherein the molar ratio of anionic surfactant to amine oxide is about 3:1.

6. The shampoo composition of claim 1 wherein said cationic polymer has a molecular weight of from about 1,000 to about 10,000,000 and a charge density from about 0.3 meq/gm to about 7 meq/gm.

7. The shampoo composition of claim 1 wherein said cationic polymer has a molecular weight of from about 20,000 to about 2,000,000.

8. The shampoo composition of claim 1 wherein said cationic polymer has a charge density of from about 0.7 meq/gm to about 5 meq/gm.

9. A shampoo composition comprising:
a. from about 5 to about 50 wt. % of a detersive surfactant composition;
b. from about 0.1 to about 20 wt. % amine oxide;
c. from about 0.01 to about 5 wt. % cationic polymer; and
d. from about 0.1 to 10 wt. % soil penetration agent.

10. The shampoo composition of claim 9 wherein said detersive surfactant composition comprises a surfactant selected from the group consisting of anionic surfactants, zwitterionic surfactants, cationic surfactants, nonionic surfactants, and combinations thereof.

11. The shampoo composition of claim 9 wherein said detersive surfactant composition comprises at least one anionic surfactant.

12. The shampoo composition of claim 11 wherein said anionic surfactant is selected from the group consisting of ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, triethanolamine lauryl sulfate, monoethanolamine cocoyl sulfate, monoethanolamine lauryl sulfate, sodium tridecyl benzene sulfonate, sodium dodecyl benzene sulfonate, sodium cocoyl isethionate, and mixtures thereof.

13. The shampoo composition of claim 9 wherein said amine oxide is selected from the group consisting of dimethyl-dodecylamine oxide, oleyldi(2-hydroxyethyl) amine oxide, dimethyltetradecylamine oxide, di(2-hydroxyethyl)-tetradecylamine oxide, dimethylhexadecylamine oxide, behenamine oxide, cocamine oxide, decyltetradecylamine oxide, dihydroxyethyl C12-15 alkoxypropylamine oxide, dihydroxyethyl cocamine oxide, dihydroxyethyl lauramine oxide, dihydroxyethyl stearamine oxide, dihydroxyethyl tallowamine oxide, hydrogenated palm kernel amine oxide, hydrogenated tallowamine oxide, hydroxyethyl hydroxypropyl C12-15 alkoxypropylamine oxide, lauramine oxide, myristamine oxide, myristyl/cetyl amine oxide, oleamidopropylamine oxide, oleamine oxide, palmitamine oxide, PEG-3 lauramine oxide, dimethyl lauramine oxide, potassium trisphosphonomethylamine oxide, stearamine oxide, and tallowamine oxide.

14. The shampoo composition of claim 11 wherein the molar ratio of anionic surfactant to amine oxide is about 2:1 to about 40:1.

15. The shampoo composition of claim 11 wherein the molar ratio of anionic surfactant to amine oxide is about 2:1 to about 10:1.

16. The shampoo composition of claim 11 wherein the molar ratio of anionic surfactant to amine oxide is about 3:1.

17. The shampoo composition of claim 9 wherein said cationic polymer has a molecular weight of from about 1,000 to about 10,000,000 and a charge density from about 0.3 meq/gm to about 7 meq/gm.

18. The shampoo composition of claim 9 wherein said cationic polymer has a molecular weight of from about 20,000 to about 2,000,000.

19. The shampoo composition of claim 9 wherein said cationic polymer has a charge density of from about 0.7 meq/gm to about 5 meq/gm.
